(19) United States
(12) Patent Application Publication
(10) Pub. No.: US 2008/0003941 A1
(43) Pub. Date: Jan. 3, 2008

(54) VoIP two-way broadcasting

(75) Inventors: David Milstein, Redmond, WA (US); Kuansan Wang, Bellevue, WA (US); Linda Criddle, Kirkland, WA (US); Lon-Chan Chu, Redmond, WA (US); Scott C. Forbes, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/480,752

(22) Filed: Jun. 30, 2006

(51) Int. Cl. H04H 1/00

(52) U.S. Cl. 455/3.01

(57) ABSTRACT

A method and system for providing an ability to have two-way broadcasting in a VoIP system is provided. A call center may originate or relay a broadcast message to several clients. When a third party requests to broadcast a message, or specified triggering events are detected, content of the message may be collected and composed, and a group of recipient clients identified based on the content of the message. An individual broadcast message may be formatted, scheduled and transmitted based on the profile information of the recipient client(s). Moreover, a set of rules to specify the process of broadcasting may be provided from the third party and the service provider. For example, based on a set of rules, a next group of recipient clients may be determined after the initial broadcast and different broadcast messages may be formatted for each recipient client and transmitted.

### BACKGROUND

Generally described, an Internet telephony system provides an opportunity for users to have a call connection with enhanced calling features compared to a conventional Public Switched Telephone Network (PSTN)-based telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of communications, ability to establish and control multimedia communication, and the like. VoIP technology will likely continue to gain favor because of its ability to provide enhanced calling features and advanced services which the traditional telephony technology has not been able to provide. One of the advanced services includes broadcasting emergency messages to a massive number of people without a significant delay. However, under the current VoIP approach, most emergency messages are broadcast via one-way communications. Further, the current VoIP approaches do not provide a method or a system to allow a call center to have two-way broadcasting communications with its clients when the clients need some assistance with respect to the emergency messages or need to report other problems associated with the emergency messages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Generally described, a method and system provides an ability to have two-way broadcasting in a VoIP system. A call center may originate or relay a broadcast message to several clients. When a third party requests to broadcast a message, or specified triggering events are detected, the content of the message may be collected and composed, and a group of recipient clients identified based on the content of the message. An individual broadcast message may be formatted, scheduled and transmitted based on the profile information of the recipient client(s). Moreover, a set of rules may be predefined by the call center, the third party, etc., to specify the process of broadcasting. For example, based on a set of rules, a next group of recipient clients may be determined after the initial broadcast and different broadcast messages may be formatted for each recipient client and transmitted.

In accordance with an aspect of the present invention, a method for two-way message broadcasting over a digital voice communication channel is provided. The method includes composing the content of a broadcast message, identifying a first group of recipient clients based on the content, and formatting at least one broadcast message suitable for each recipient client from the first group to receive. Each formatted broadcast message is transmitted to its corresponding recipient client. In return, a response to the transmitted broadcast message may be received. When the broadcast messages are formatted, the broadcast messages are scheduled such that each recipient client is ensured to receive at least one broadcast message via its devices. In addition, broadcast messages can be scheduled based on priority information of the recipient clients. Upon receipt of the response, an appropriate action is determined and performed. After the initial broadcast, a next group of recipient clients may be determined based on the response. Again, different broadcast messages may be formatted for each recipient client and transmitted based on a schedule.

In accordance with another aspect of the present invention, a method for communicating a two-way broadcast message via a VoIP device is provided. The VoIP device receives a broadcast message from an authorized call center or other VoIP devices. The VoIP device processes the received broadcast message and determines an appropriate action based on user inputs. The VoIP device may compose content of a device broadcast message which is suitable for transmission among devices. Subsequently, based on a set of rules and/or instructions which are embedded in the messages, the VoIP device may determine a group of VoIP devices which will receive the device broadcast message. The VoIP device formats a device broadcast message suitable for each device from the group of VoIP devices to receive and transmit the device broadcast message to each corresponding device. When the VoIP device receives a confirmation of receipt about the transmitted device broadcast message, the VoIP device forwards the received confirmation to the authorized party.

In accordance with yet another aspect of the present invention, a computer-readable medium having computer-executable components for two-way broadcasting is provided. The computer-readable medium includes a message component, a recipient device component, and a broadcasting component. The message component is configured to receive a request to broadcast a message and to generate content of the message. Based on the request, the recipient device component is configured to determine available devices of a recipient client. A broadcast message is formatted and transmitted to the available device by a broadcasting component. The broadcast message may be tailored for an available device of the recipient client, including part of the content of the message. In addition, the computer-readable medium includes a communicating component which is configured to receive a response to the broadcast message and further communicate with the available device.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a VoIP environment for establishing a conversation channel between various clients in accordance with an aspect of the present invention;

FIG. 2 is a block diagram illustrative of a VoIP client in accordance with an aspect of the present invention;

FIG. 3 is a block diagram illustrative of various components associated with a VoIP device in accordance with an aspect of the present invention;

FIG. 4 is a block diagram illustrative of the exchange of data between two VoIP clients over a conversation channel in accordance with an aspect of the present invention;

FIG. 5 is a block diagram of a data packet used over a communication channel established in the VoIP environment of FIG. 1;

FIG. 6 is a block diagram illustrating interactions between two VoIP clients for transferring contextual information defined by identified structured hierarchies in accordance with an aspect of the present invention;

FIGS. 7A-7C are block diagrams illustrating interactions among VoIP entities for two-way broadcasting in accordance with an aspect of the present invention;

FIGS. 8A-8E are block diagrams illustrative of various attributes and classes of structured hierarchies corresponding to VoIP contextual information in accordance with an aspect of the present invention;

FIG. 9 is a flow diagram illustrating a routine for a two-way broadcasting of a message in accordance with an aspect of the present invention; and

FIG. 10 is a flow diagram illustrating a subroutine utilized in FIG. 9 for formatting a message in accordance with an aspect of the present invention.

### DETAILED DESCRIPTION

Generally described, the present invention relates to a method and system for broadcasting a message over a two-way communication channel. More specifically, the present invention relates to a method and system for identifying a group of recipient clients, and generating and transmitting a broadcast message in accordance with the profile information of each recipient client. In order to format and schedule broadcast messages, information relating to recipient clients and the broadcast message may be exchanged as part of a VoIP conversation. A VoIP conversation is a data stream of information related to a conversation, such as contextual information and voice information, exchanged over a communication channel. For example, the profile information of the recipient clients is exchanged as part of contextual information represented according to “structured hierarchies” a two-way communication channel. “Structured hierarchies,” as used herein, are predefined organizational structures for arranging contextual information to be exchanged between two or more VoIP devices. For example, structured hierarchies may be XML namespaces. Although the present invention will be described with relation to illustrative structured hierarchies and an IP telephony environment, one skilled in the relevant art will appreciate that the disclosed embodiments are illustrative in nature and should not be construed as limiting.

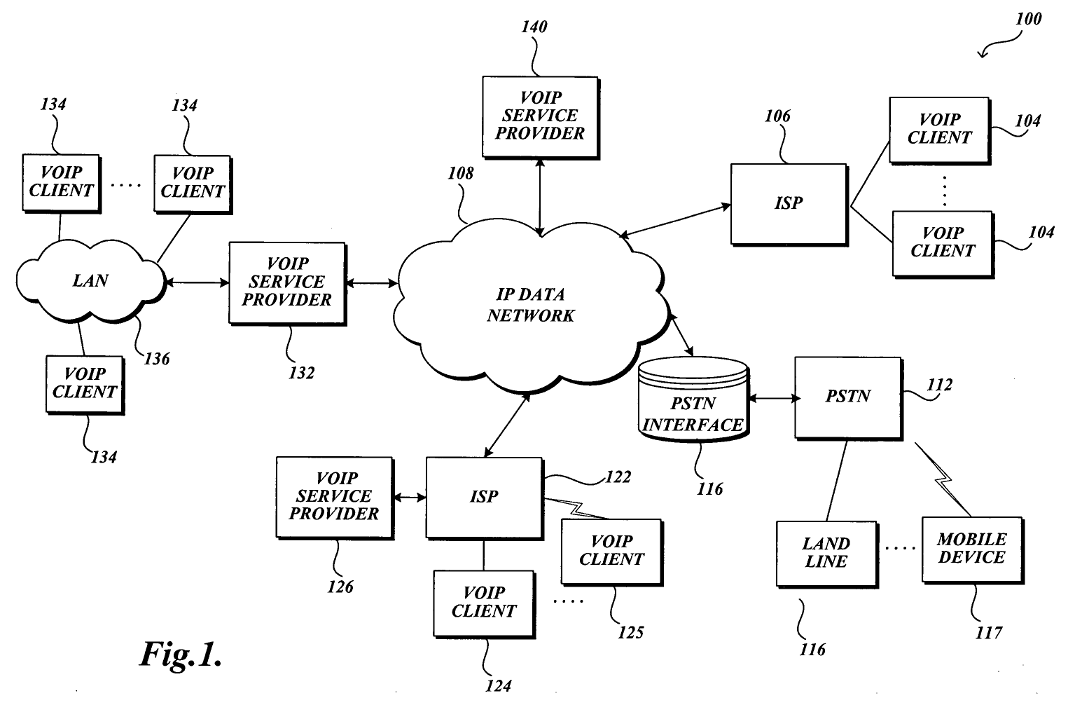

With reference to FIG. 1, a block diagram of an IP telephony environment 100 for providing IP telephone services between various “VoIP clients” is shown. A “VoIP client,” as used herein, refers to a particular contact point, such as an individual, an organization, a company, etc., one or more associated VoIP devices, and a unique VoIP client identifier. For example, a single individual, five associated VoIP devices, and a unique VoIP client identifier collectively make up a VoIP client. Similarly, a company including five hundred individuals and over one thousand associated VoIP devices may also be collectively referred to as a VoIP client and that VoIP client may be identified by a unique VoIP client identifier. Moreover, VoIP devices may be associated with multiple VoIP clients. For example, a computer (a VoIP device) located in a residence in which three different individuals live, each individual associated with separate VoIP clients, may be associated with each of the three VoIP clients. Regardless of the combination of devices, the unique VoIP client identifier may be used within a voice system to reach the contact point of the VoIP client.

Generally described, the IP telephony environment 100 may include an IP data network 108 such as the Internet, an intranet network, a wide area network (WAN), a local area network (LAN), and the like. The IP telephony environment 100 may further include VoIP service providers 126, 132 providing VoIP services to VoIP clients 124, 125, 134. A VoIP call conversation may be exchanged as a stream of data packets corresponding to voice information, media information, and/or contextual information. As will be discussed in greater detail below, the contextual information includes metadata (information of information) relating to the VoIP conversation, the devices being used in the conversation, the contact point of the connected VoIP clients, and/or individuals that are identified by the contact point (e.g., employees of a company).

The IP telephony environment 100 may also include third party VoIP service providers 140. The VoIP service providers 126, 132, 140 may provide various calling features, such as incoming call-filtering, text data, voice and media data integration, and the integrated data transmission as part of a VoIP call conversation. VoIP clients 104, 124, 125, 134 may collect, maintain, and provide contextual information relating to a request signal for a communication channel. In addition, the VoIP service providers 126, 132, 140 may be any VoIP related service providers, including a call center, a customer support center, a VoIP service provider, an interactive E-commerce server, a centralized client information management server, and the like. The VoIP service providers 126, 132, 140 also collect, maintain, and provide a separated set of information (e.g., provider contextual information) for providing services (requested, self-configured) for VoIP clients 104, 124, 125, 134 communicating in a call conversation. The VoIP service providers 126, 132, 140 may route a request signal for a communication channel to an appropriate destination and contextual information which may assist the appropriate destination in providing the requested service.

VoIP service providers 132 may be coupled to a private network such as a company LAN 136, providing IP telephone services (e.g., internal calls within the private network, external calls outside of the private network, and the like) and multimedia data services to several VoIP clients 134 communicatively connected to the company LAN 136. Similarly, VoIP service providers, such as VoIP service provider 126, may be coupled to Internet Service Provider (ISP) 122, providing IP telephone services and VoIP services for clients of the ISP 122.

In one embodiment, one or more ISPs 106, 122 may be configured to provide Internet access to VoIP clients 104, 124, 125 so that the VoIP clients 104, 124, 125 can maintain conversation channels established over the Internet. The VoIP clients 104, 124, 125 connected to the ISP 106, 122 may use wired and/or wireless communication lines. Further, each VoIP client 104, 124, 125, 134 can communicate with the PSTN 112. A PSTN interface 114 such as a PSTN gateway may provide access between PSTN and the IP data network 108. The PSTN interface 114 may translate VoIP data packets into circuit switched voice traffic for PSTN and vice versa. The PSTN 112 may include a land line device 116, a mobile device 117, and the like.

Conventional voice devices, such as land line 116, may request a connection with the VoIP client based on the unique VoIP identifier of that client, and the appropriate VoIP device associated with the VoIP client will be used to establish a connection. In one example, an individual associated with the VoIP client may specify which devices are to be used in connecting a call based on a variety of conditions (e.g., connection based on the calling party, the time of day, etc.).

It is understood that the above-mentioned configuration in the environment 100 is merely exemplar. It will be appreciated by one of ordinary skill in the art that any suitable configurations with various VoIP entities can be part of the environment 100. For example, VoIP clients 134 coupled to LAN 136 may be able to communicate with other VoIP clients 104, 124, 125, 134 with or without VoIP service providers 132 or ISP 106, 122. Further, an ISP 106, 122 can also provide VoIP services to its client.

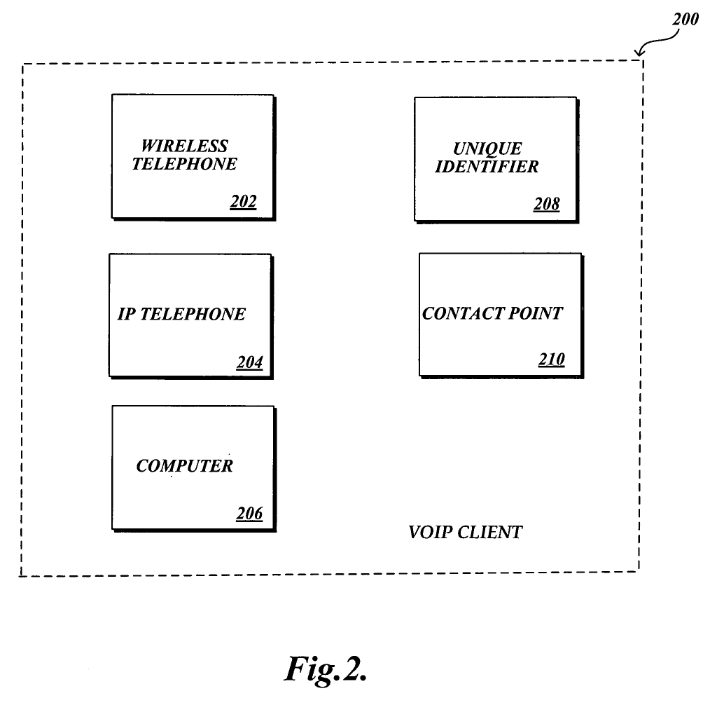

Referring now to FIG. 2, a block diagram illustrating an exemplary VoIP client 200 that includes several VoIP devices and a unique VoIP identifier, in accordance with an embodiment of the present invention, is shown. Each VoIP device 202, 204, 206 may include a storage that is used to maintain voice messages, address books, client specified rules, priority information related to incoming calls, etc. Alternatively, or in addition thereto, a separate storage, maintained, for example, by a service provider, may be associated with the VoIP client and accessible by each VoIP device that contains information relating to the VoIP client. In one embodiment, any suitable VoIP device such as a wireless phone 202, an IP phone 204, or a computer 206 with proper VoIP applications may be part of the VoIP client 200. The VoIP client 200 also maintains one or more unique client identifiers 208. The unique client identifier(s) 208 may be constant or change over time. For example, the unique client identifier(s) 208 may change with each call. The unique client identifier is used to identify the client and to connect with the contact point 210 associated with the VoIP client. The unique client identifier may be maintained on each VoIP device included in the VoIP client and/or maintained by a service provider that includes an association with each VoIP device included in the VoIP client. In the instance in which the unique client identifier is maintained by a service provider, the service provider may include information about each associated VoIP device and knowledge as to which device(s) to connect for incoming communications. In an alternative embodiment, the VoIP client 200 may maintain multiple VoIP identifiers. In this embodiment, a unique client identifier may be temporarily assigned to the VoIP client 200 for each call session.

The unique client identifier may be used similarly to a telephone number in PSTN. However, instead of dialing a typical telephone number to ring a specific PSTN device, such as a home phone, the unique client identifier is used to reach a contact point, such as an individual or company, which is associated with the VoIP client. Based on the arrangement of the client, the appropriate device(s) will be connected to reach the contact point. In one embodiment, each VoIP device included in the VoIP client may also have its own physical address in the network or a unique device number. For example, if an individual makes a phone call to a POTS client using a personal computer (VoIP device), the VoIP client identification number in conjunction with an IP address of the personal computer will eventually be converted into a telephone number recognizable in PSTN.

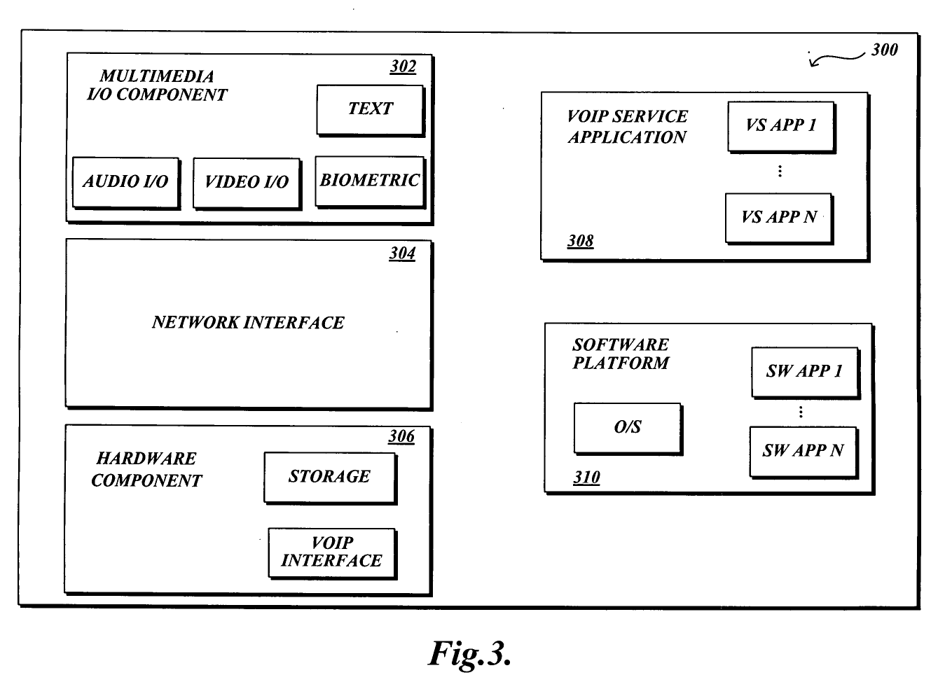

FIG. 3 is a block diagram of a VoIP device 300 that may be associated with one or more VoIP clients and used with embodiments of the present invention. It is to be noted that the VoIP device 300 is described as an example. It will be appreciated that any suitable device with various other components can be used with embodiments of the present invention. For utilizing VoIP services, the VoIP device 300 may include components suitable for receiving, transmitting and processing various types of data packets. For example, the VoIP device 300 may include a multimedia input/output component 302 and a network interface component 304. The multimedia input/output component 302 may be configured to input and/or output multimedia data (including audio, video, and the like), user biometrics, text, application file data, etc.

The multimedia input/output component 302 may include any suitable user input/output components such as a microphone, a video camera, a display screen, a keyboard, user biometric recognition devices, and the like. The multimedia input/output component 302 may also receive and transmit multimedia data via the network interface component 304. The network interface component 304 may support interfaces such as Ethernet interfaces, frame relay interfaces, cable interfaces, DSL interfaces, token ring interfaces, radio frequency (air interfaces), and the like. The VoIP device 300 may comprise a hardware component 306 including permanent and/or removable storage such as read-only memory devices (ROM), random access memory (RAM), hard drives, optical drives, and the like. The storage may be configured to store program instructions for controlling the operation of an operating system and/or one or more applications, and to store contextual information related to individuals (e.g., voice profiles, user biometrics information, etc.) associated with the VoIP client in which the device is included. In one embodiment, the hardware component 306 may include a VoIP interface card which allows a non-VoIP client device to transmit and receive a VoIP conversation.

The device 300 may further include a software platform component 310 for the operation of the device 300 and a VoIP service application component 308 for supporting various VoIP services. The VoIP service application component 308 may include applications such as data packet assembler/disassembler applications, a structured hierarchy parsing application, audio Coder/Decoder (CODEC), video CODEC and other suitable applications for providing VoIP services. The CODEC may use voice profiles to filter and improve incoming audio.

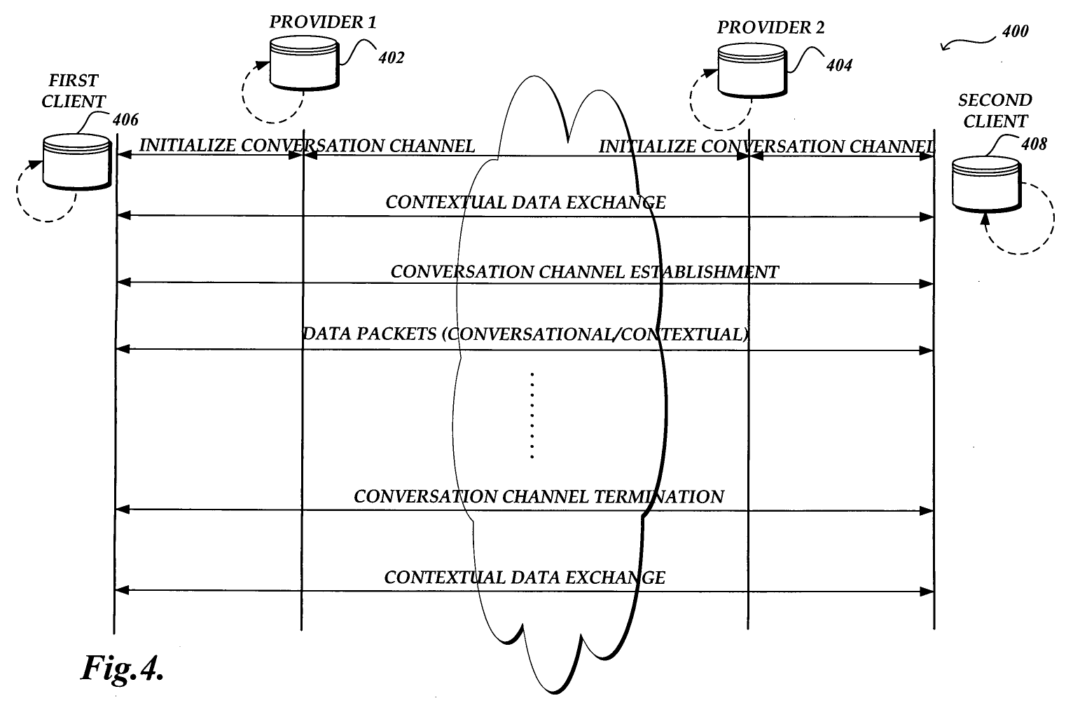

With reference to FIG. 4, a block diagram illustrative of a conversation flow 400 between VoIP devices of two different VoIP clients over a conversation channel, in accordance with an embodiment of the present invention, is shown. During a connection set-up phase, a VoIP device of a first VoIP client 406 requests to initiate a conversation channel with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 406. While this example utilizes two VoIP service providers and two VoIP clients, any number and combination of VoIP clients and/or service providers may be used with embodiments of the present invention. For example, only one service provider may be utilized in establishing the connection. In yet another example, communication between VoIP devices may be direct, utilizing public and private lines, thereby eliminating the need for a VoIP service provider. In a peer to peer context, communication between VoIP devices may also be direct without having any service providers involved.

There are a variety of protocols that may be selected for use in exchanging information between VoIP clients, VoIP devices, and/or VoIP service providers. For example, when Session Initiation Protocol (SIP) is selected for a signaling protocol, session control information and messages will be exchanged over a SIP signaling path/channel and media streams will be exchanged over a Real-Time Transport Protocol (RTP) path/channel. For the purpose of discussion, a communication channel, as used herein, generally refers to any type of data or signal exchange path/channel. Thus, it will be appreciated that depending on the protocol, a connection set-up phase and a connection termination phase may require additional steps in the conversation flow 400.

For ease of explanation, consider an example in which, the first VoIP client 406 and the second VoIP client 408 each include only one VoIP device. Accordingly, the discussion provided herein will refer to connection of the two VoIP devices. The individual using the device of the first VoIP client 406 may select or enter the unique VoIP identifier of the client that is to be called. Provider 1 402 receives the request from the device of the first VoIP client 408 and determines a terminating service provider (e.g., Provider 2 404 of the second VoIP client 408) based on the unique VoIP identifier included in the request. The request is then forwarded to Provider 2 404. This call initiation will be forwarded to the device of the second VoIP client. A conversation channel between the device of the first VoIP client 406 and a device of the second VoIP client 408 can then be established.

In an illustrative embodiment, before the devices of the first VoIP client 406 and the second VoIP client 408 begin to exchange data packets, contextual information may be exchanged. As will be discussed in a greater detail below, the contextual information may be packetized in accordance with a predefined structure that is associated with the conversation. Any device associated with the first VoIP client 406, the service provider of the first VoIP client 406, or a different device/service provider may determine the structure based on the content of the contextual information. In one embodiment, the exchanged contextual information may include information relating to the calling VoIP client 406, the device, and the VoIP client 408 being called.

Available media types, rules of the calling client and/or the client being called, and the like, may also be part of the contextual information that is exchanged during the connection set-up phase. The contextual information may be processed and collected by one of the devices of the first VoIP client 406, one of the devices of the second VoIP client 408, and/or by the VoIP service providers (e.g., Provider 1 402 and Provider 2 404), depending on the nature of the contextual information. In one embodiment, the VoIP service providers 402, 404 may add/delete some information to/from the client's contextual information before forwarding the contextual information.

In response to a request to initiate a conversation channel, the second VoIP client 408 may accept the request for establishing a conversation channel or execute other appropriate actions such as rejecting the request via Provider 2 404. The appropriate actions may be determined based on the obtained contextual information. When a conversation channel is established, a device of the first VoIP client 406 and a device of the second VoIP client 408 start communicating with each other by exchanging data packets. As will be described in greater detail below, the data packets, including conversation data packets and contextual data packets, are communicated over the established conversation channel between the connected devices.

Conversation data packets carry data related to a conversation, for example, a voice data packet, or multimedia data packet. Contextual data packets carry information relating to data other than the conversation data. Once the conversation channel is established, either the first VoIP client 406 or the second VoIP client 408 can request to terminate the conversation channel. Some contextual information may be exchanged between the first VoIP client 406 and the second VoIP client 408 after the termination.

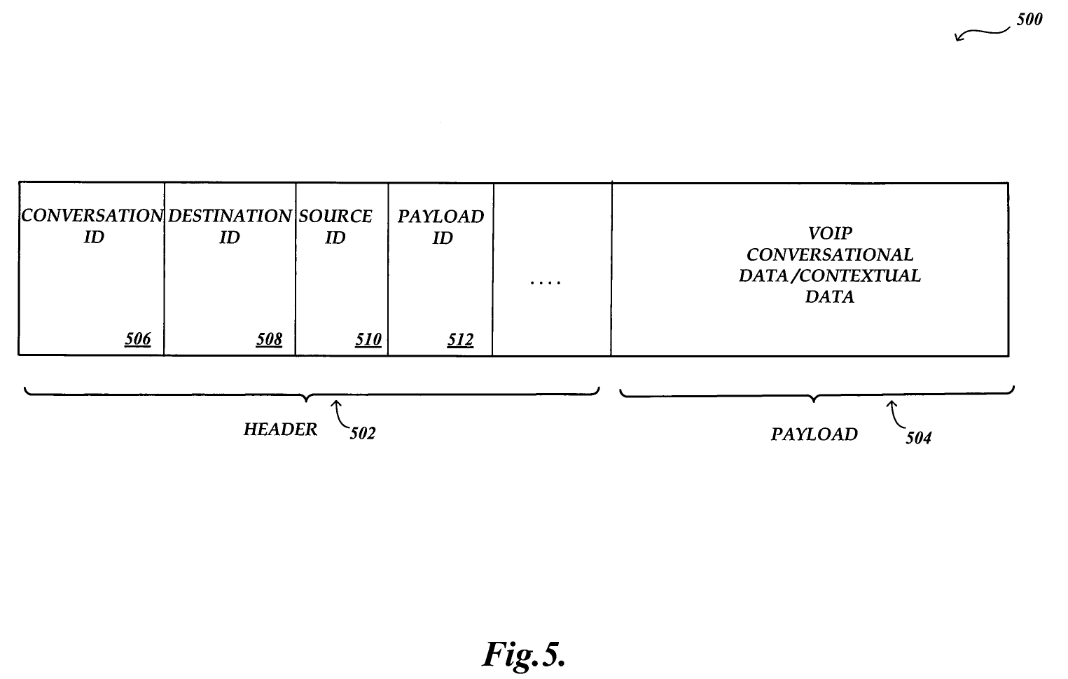

FIG. 5 is a block diagram of a data packet structure 500 used over a communication (conversation) channel in accordance with an embodiment of the present invention. The data packet structure 500 may be a data packet structure for an IP data packet suitable for being utilized to carry conversation data (e.g., voice, multimedia data, and the like) or contextual data (e.g., information relating to the VoIP services, and the like). However, any other suitable data structure can be utilized to carry conversation data or contextual data. The data packet structure 500 includes a header 502 and a payload 504. The header 502 may contain the information necessary to deliver the corresponding data packet to a destination. Additionally, the header 502 may include information utilized in the process of a conversation. Such information may include conversation ID 506 for identifying a conversation (e.g., call), a Destination ID 508, such as a unique VoIP identifier of the client being called, a Source ID 510 (unique VoIP identifier of the calling client or device identifier), Payload ID 512 for identifying the type of payload (e.g., conversation or contextual), individual ID (not shown) for identifying the individual to which the conversation data is related, and the like. In an alternative embodiment, the header 502 may contain information regarding Internet protocol versions, and payload length, among others. The payload 504 may include conversational or contextual data relating to an identified conversation. As will be appreciated by one of ordinary skill in the art, additional headers may be used for upper layer headers such as a TCP header, a UDP header, and the like.

In one embodiment of the present invention, a structured hierarchy may be predefined for communicating contextual information over a VoIP conversation channel. The contextual information may include any information relating to VoIP clients, VoIP devices, conversation channel connections (e.g., call basics), conversation context (e.g., call context), and the like. More specifically, the contextual information may include client preference, client rules, client's location (e.g., user location, device location, etc.), biometrics information, the client's confidential information, VoIP device's functionality, VoIP service provider's information, media type, media parameters, calling number priority, keywords, information relating to application files, and the like. The contextual information may be processed and collected at each VoIP client and/or the VoIP service providers depending on the nature of the contextual data. In one aspect, the VoIP service providers may add, modify and/or delete the VoIP client's contextual data before forwarding the contextual information. For example, the client's confidential information will be deleted by the VoIP service provider associated with that client unless the client authorizes such information to be transmitted. In some cases, a minimal amount of contextual information is transmitted outside of an intranet network.

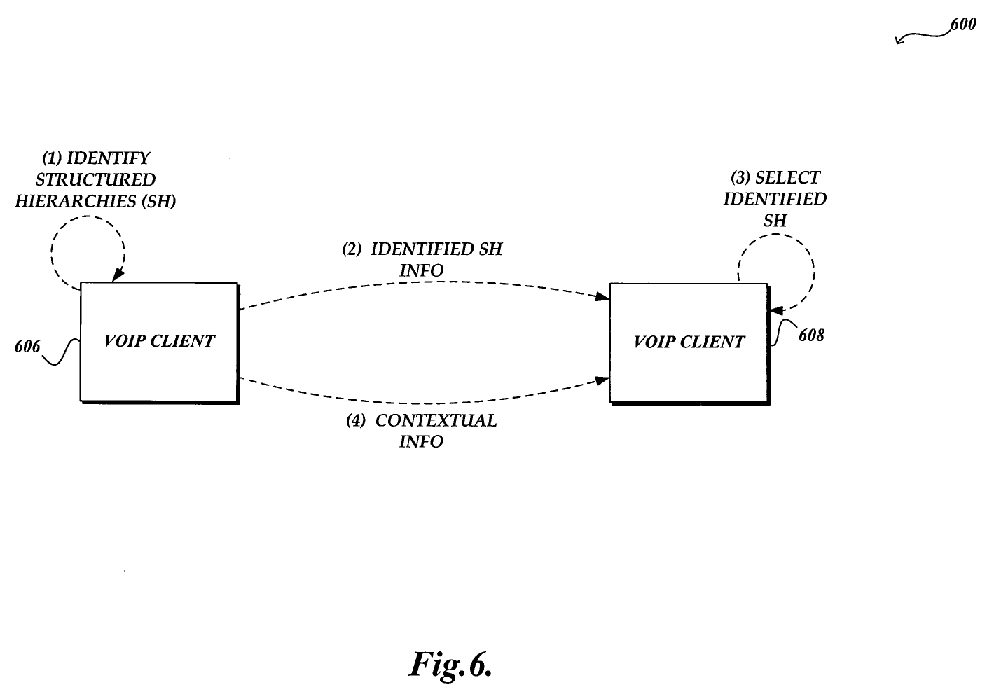

With reference to FIG. 6, a block diagram 600 illustrating interactions between two VoIP clients for transferring contextual information, in accordance with an embodiment of the present invention, is shown. As with FIG. 4, the example described herein will utilize the scenario in which each client only has one device associated therewith and the connection occurs between those two devices. In one embodiment, devices of VoIP Client 606 and VoIP Client 608 have established a VoIP conversation channel. It may be identified which structured hierarchies will be used to carry certain contextual information by VoIP Client 606. The information regarding the identified structured hierarchies may include information about which structured hierarchies are used to carry the contextual information, how to identify the structured hierarchy, and the like. Such information will be exchanged between VoIP Client 606 and VoIP Client 608 before the corresponding contextual information is exchanged. Upon receipt of the information identifying which structured hierarchy will be used to carry the contextual information, VoIP Client 608 looks up predefined structured hierarchies (e.g., XML namespace and the like) to select the identified structured hierarchies. In one embodiment, the predefined structured hierarchies can be globally stored and managed in a centralized location accessible from a group of VoIP clients. In this embodiment, a Uniform Resource Identifier (URI) address of the centralized location may be transmitted from VoIP Client 606 to VoIP Client 608.

In another embodiment, each VoIP client may have a set of predefined structured hierarchies stored in a local storage of any devices or a dedicated local storage which all devices can share. The predefined structured hierarchies may be declared and agreed upon between VoIP clients before contextual information is exchanged. In this manner, the need to provide the structure of the contextual data packets may be eliminated and thus the amount of transmitted data packets corresponding to the contextual data is reduced. Further, by employing the predefined structured hierarchies, data packets can be transmitted in a manner which is independent of hardware and/or software.

Upon retrieving the identified structured hierarchy, VoIP Client 608 is expecting to receive a data stream in which data packets corresponding to the data stream are defined according to the identified structured hierarchies. VoIP Client 606 can begin sending contextual information represented in accordance with the identified structured hierarchies. In one embodiment, VoIP Client 608 starts a data binding process with respect to the contextual information. For example, instances of the identified structured hierarchies may be constructed with the received contextual information.

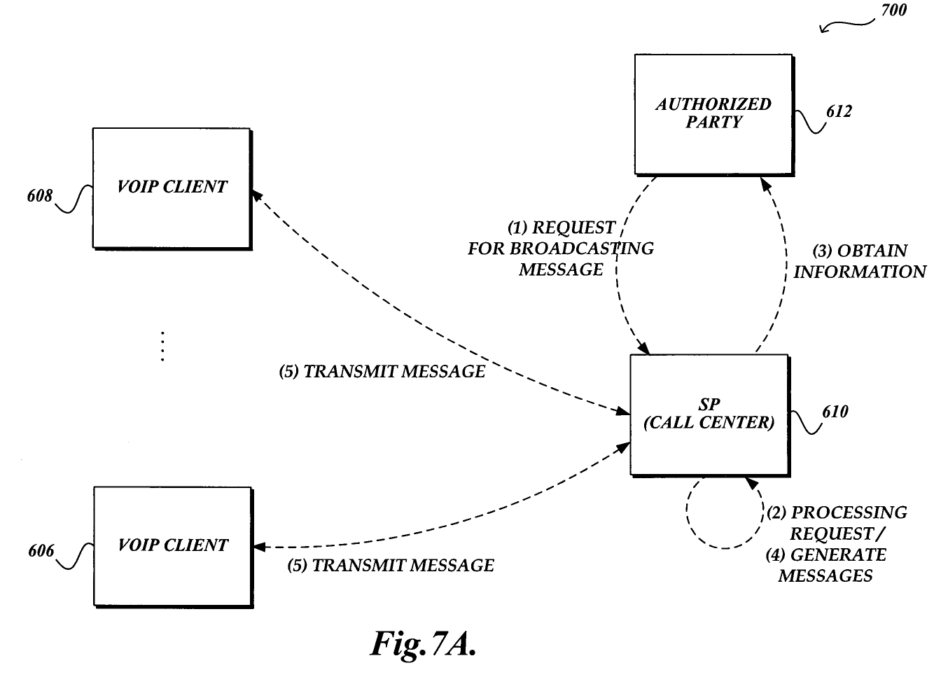

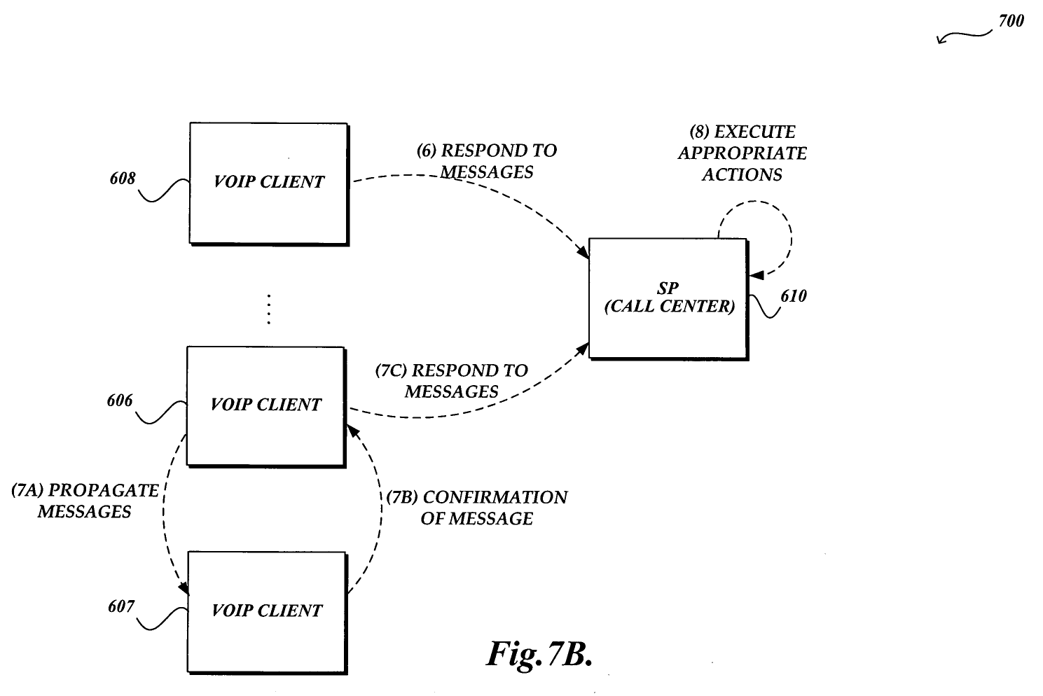

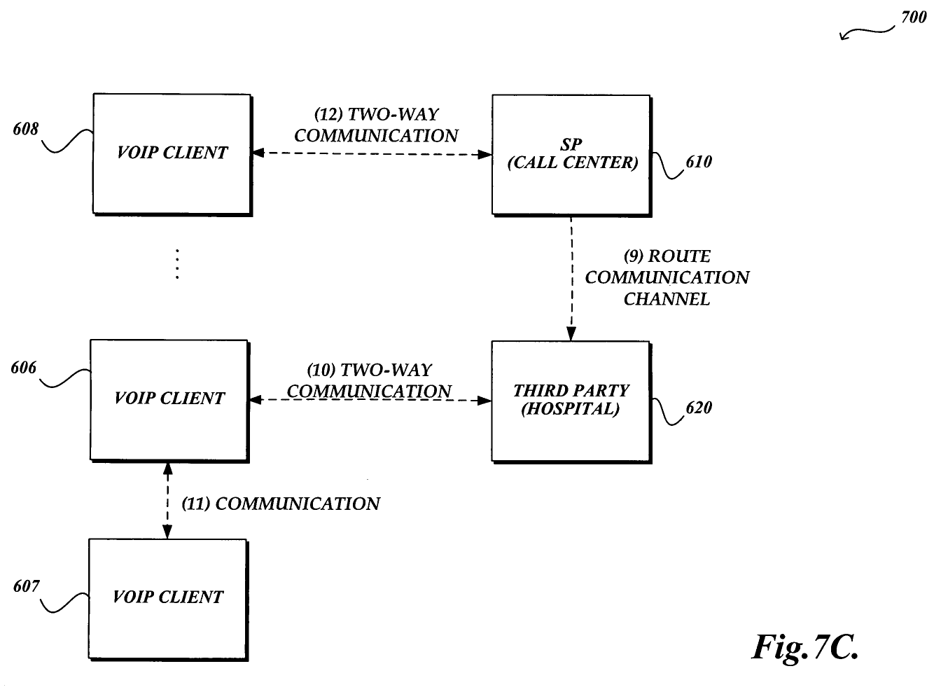

FIGS. 7A-7C are block diagrams 700 illustrating two-way broadcasting among VoIP entities in accordance with an embodiment of the present invention. In one embodiment, the VoIP entities may include VoIP clients, VoIP service providers for the clients, third party service providers, and the like. For discussion purposes, assume that a call center 610 is in charge of broadcasting emergency messages to its clients 606, 608 in one geographic area. The call center 610 can create an emergency message upon detection of emergencies such as a cable line down due to hurricane. Likewise, the call center can formulate an emergency message upon receipt of a request from emergency broadcast organizations (e.g., fire station, Federal Emergency Management Agent (FEMA), etc) to broadcast a particular emergency message. In one embodiment, the emergency broadcast organizations have been pre-authorized to broadcast such emergency message. The call center and the emergency broadcast organizations may have a prearranged agreement how to determine the scope of recipient clients, priority of clients, priority of messages, etc. It is to be understood that, although examples discussed FIGS. 7A-7C are generally focused on an emergency broadcast message, it is contemplated that an originator or a propagator can broadcast any type of messages to recipient VoIP clients over two-way communication channels.

With reference to FIG. 7A, in one embodiment, an authorized party 612 may send a request to broadcast a message to a Service Provider (SP) 610. SP 610 may be a service provider on premises (e.g., part of a client if the client is a corporation) or a service provider off premises (an external service provider). As will be described in greater detail below, SP 610 may be any VoIP related service provider, including a call center, a VoIP service provider, and the like. SP 610 may process the request and send a response to obtain necessary information from the authorized party 612. For example, SP 610 may need to have more information as to which group of clients should be notified first, with what level of detail, for how long, etc. SP 610 generates a broadcast message based on the obtained information. Subsequently, SP 610 transmits the broadcast message to its clients 608, 606. In one embodiment, several broadcast messages may be generated for a client and stored in a queue based on a schedule.

For discussion purposes, assume that a city emergency center contacted a call center for an emergency broadcasting about a flood in a river. Upon receipt of the request, the call center composes the content of a message (e.g., flood warning). The call center may need additional information, for example profile information of recipient clients, a set of rules indicating which group of clients should be notified first, with what level of detail, etc. The call center may obtain such necessary information from the city emergency center. Based on this information, the call center may identify several groups of clients who should receive the flood warning message. A first group of clients may be clients traveling or residing near the flooded area. A second group of clients may be clients who can be influenced by the flood within an hour, and so on.

In an illustrative embodiment, the call center generates a broadcast message which is formulated for each group and/or each client. Specifically, each client may have a limited number of devices currently available for receiving a broadcast message. In one embodiment, a broadcast message may be formulated based on the functionality of at least one available device of each client. For example, Bob, a client of the call center, forgot to bring his mobile phone but has a laptop with him. The call center may formulate and send a broadcast message to Bob's laptop. Upon receipt of the message, Bob tries to contact the call center to ask a safe direction which will lead away from the flood. The call center may route Bob to a contact (e.g., agent, Interactive Voice Recognition System (IVRS), operator, etc.) of the call center, a third party service provider, or a public help center which is ready for further assistance.

Referring to FIG. 7B, VoIP Clients 606 may respond to the broadcast message by sending a confirmation of receipt (positive acknowledgment), sending a failure of receipt (negative acknowledgment), sending a request to communicate, etc. In one embodiment, some clients cannot be reached by SP 610 but can be reached by a certain client of SP 610. In this embodiment, SP 610 may designate the client to propagate the received messages to other clients. For example, VoIP Client 606 propagates the received broadcast message to VoIP Client 607 which has not received the broadcast message from SP 610. VoIP Client 607 sends a confirmation of receipt to VoIP Client 606. Subsequently, VoIP Client 606 sends the confirmation received from VoIP Client 607 along with its own response. Returning back to the flood emergency example, Bob may wish to contact a hospital for providing CPR to his friend while Bob is communicating with the call center. The call center may route the communication channel connection to a hospital and eventually Bob and the hospital will have an established communication channel. In some cases, the call center, the hospital, and Bob may be connected via a multiparty communication channel.

Referring to FIG. 7C, VoIP Client 606 has sent a response in order to request a reroute of a communication channel to a third-party 620. Subsequently, SP 610 routes a communication channel connection to a third party 620 so that the third party (e.g., a hospital, etc.) 620 and VoIP Client 606 can communicate. In one embodiment, VoIP Client 607 can communicate with third party 620 via the VoIP Client 606. VoIP Client 608 may have sent a request to SP 610 to have a two-way communication with SP 610. VoIP Client 608 and SP 610 (i.e., a contact person, an agent, etc.) may begin exchanging a conversation which includes voice information, media information, and contextual information.

In one embodiment, SP 610 has already obtained contextual information including priority information from the authorized party 612 (which requested to broadcast messages). Further, SP 610 may maintain own priority information corresponding to VoIP clients. As will be described in greater detail below, it is contemplated that structured hierarchies are utilized to carry contextual information (contextual data packets) between several VoIP entities in this illustrative embodiment. SP 610 processes the contextual information to identify what information will be further collected and which appropriate source will be contacted or queried, to obtain the identified information. However, the initial contextual information obtained from the authorized party 612 may be sufficient enough for SP 610 to broadcast messages. In some instances, several message broadcasts to clients may be necessary. With each broadcast, the size or scope of the recipient clients and/or content of the messages may vary. The authorized party 612 may provide contextual information including a set of rules which specify how to format, schedule, and transmit messages to clients. For example, a flood message may be read in Spanish for end users who have specified Spanish language preferences. Alternatively, a flood message for a first device may be formatted to be in combination of an audible alarm and a text message while a flood message for a second device may be formatted to be a voice recording based on the set of rules.

Further, SP 610 can request the identified information necessary for message broadcast and obtain the information from a third party SP. SP 610 and the third party may exchange more information, including the client's contextual information relating to the VoIP Client 606, 607, 608. In an illustrative embodiment, upon receipt of the request, SP 610 obtains (or collects) any readily available contextual information, for example, previously obtained contextual information related to VoIP Client 606, devices, previous communications, service history, and the like, from its database.

In one embodiment, the structured hierarchies may be defined by Extensible Markup Language (XML). However, it is to be appreciated that the structured hierarchies can be defined by any language suitable for implementing and maintaining extensible structured hierarchies. Generally described, XML is well known for a cross-platform, software and hardware independent tool for transmitting information. Further, XML maintains its data as a hierarchically-structured tree of nodes, each node comprising a tag that may contain descriptive attributes. Typically, XML namespace is provided to give the namespace a unique name. In some instances, the namespace may be used as a pointer to a centralized location containing default information about the namespace.

In accordance with an illustrative embodiment, while the communication channel is being established, VoIP Client 606 may identify a XML namespace for contextual information. For example, the XML namespace attribute may be placed in the start tag of a sending element. It is to be understood that XML namespaces, attributes, and classes illustrated herein are provided merely as an example of structured hierarchies used in conjunction with various embodiments of the present invention. After SP 610 receives the XML namespace information, the VoIP Client 606 transmits a set of contextual data packets, defined in accordance with the identified XML namespace, to SP 610. When a namespace is defined in the start tag of an element, all child elements with the same prefix are associated with the same namespace. As such, SP 610 and VoIP Client 606 can transmit contextual information without including prefixes in all the child elements, thereby reducing the amount of data packets transmitted for the contextual information. Likewise, VoIP Client 608 and the third party 620 exchange the XML namespace information and a set of contextual data packets, defined in accordance with the identified XML namespace.

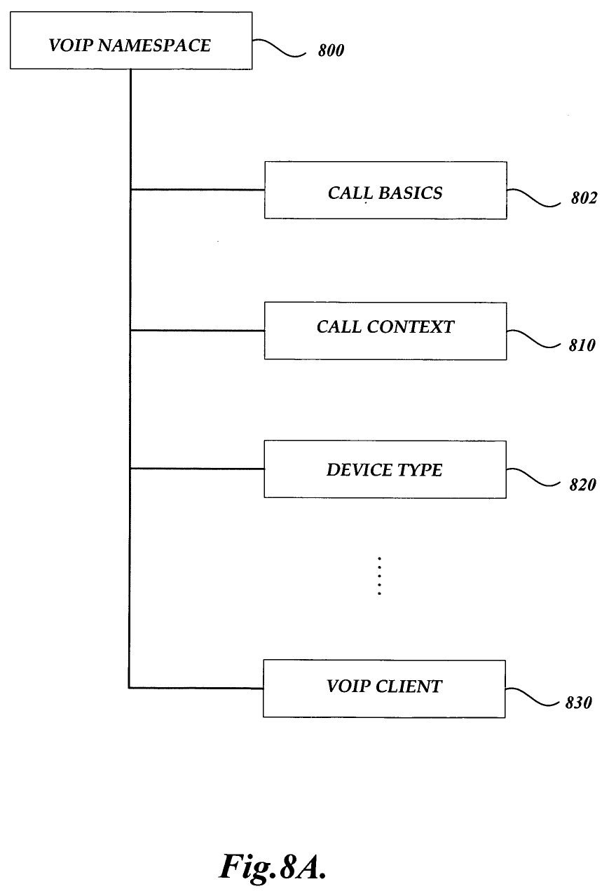

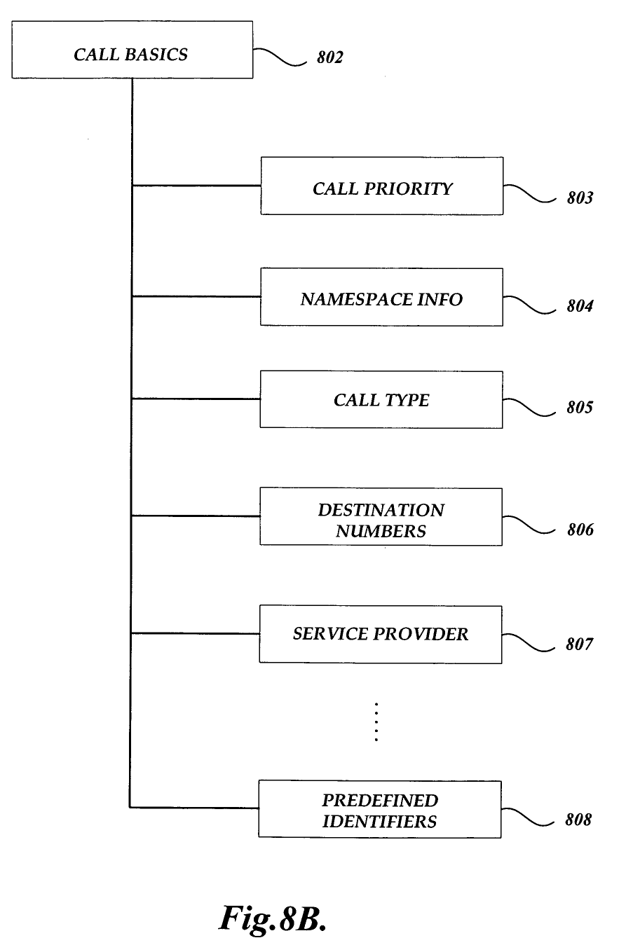

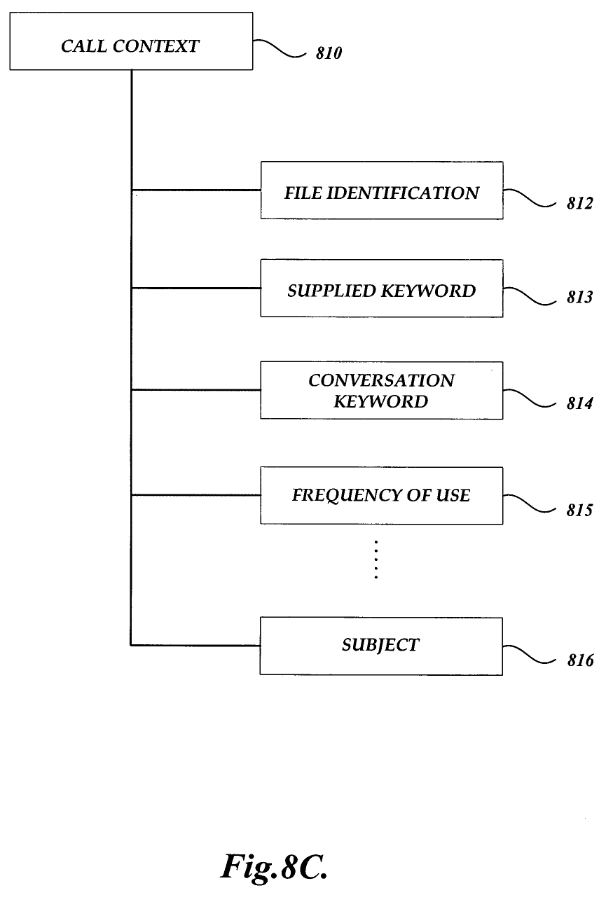

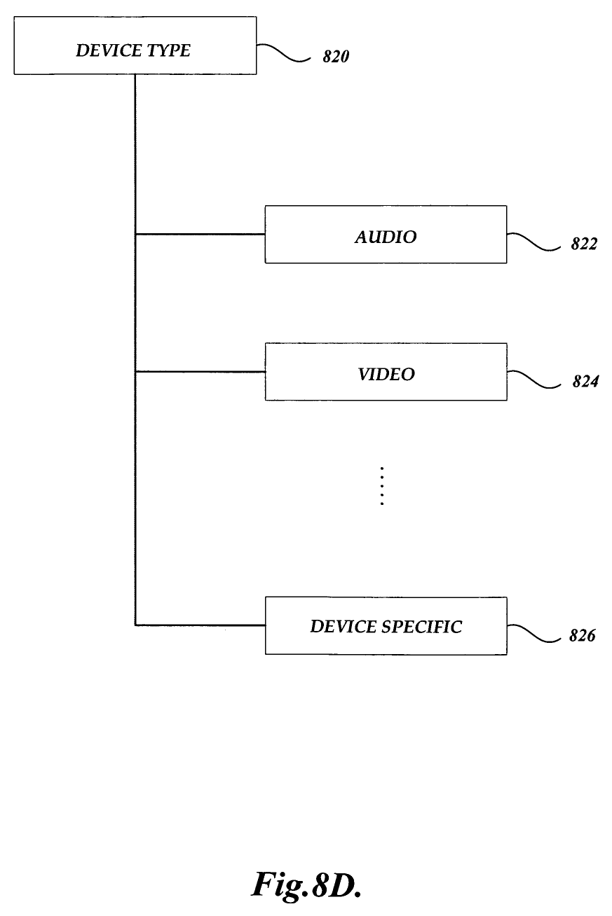

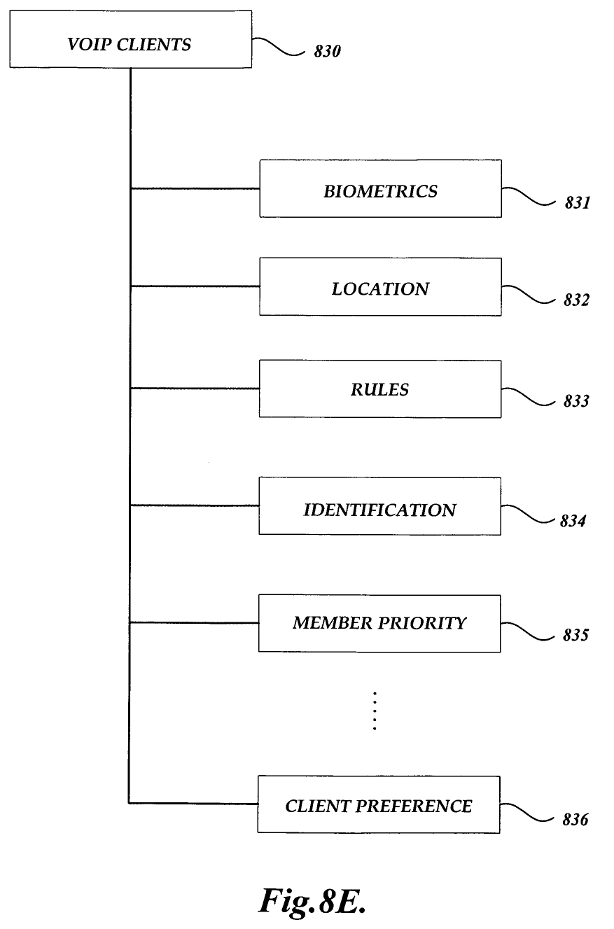

With reference to FIGS. 8A-8E, block diagrams illustrative of various classes and attributes of structured hierarchies corresponding to VoIP contextual information are shown. The VoIP contextual information exchanged between various VoIP entities (e.g., clients, service providers, etc.) may correspond to a VoIP namespace 800. In one embodiment, the VoIP namespace 800 is represented as a hierarchically structured tree of nodes, each node corresponding to a subclass that corresponds to a subset of VoIP contextual information. For example, a VoIP namespace 800 may be defined as a hierarchically structured tree comprising a call basics class 802, a call contexts class 810, a device type class 820, a VoIP client class 830, and the like.

With reference to FIG. 8B, a block diagram of a call basics class 802 is shown. In an illustrative embodiment, the call basics class 802 may correspond to a subset of VoIP contextual information relating to a conversation channel connection (e.g., a PSTN call connection, a VoIP call connection, and the like). The subset of the VoIP contextual information relating to a conversation channel connection may include originating numbers (e.g., a caller's VoIP ID number), destination numbers (e.g., callees' VoIP ID numbers, or telephone numbers), call connection time, VoIP service provider related information, and/or ISP related information, such as IP address, MAC address, namespace information, and the like. Additionally, the contextual information relating to a conversation channel connection may include call priority information (which defines the priority levels of the destination numbers), call type information, and the like. The call type information may indicate whether the conversation channel is established for an emergency communication, a broadcasting communication, a computer-to-computer communication, a computer to POTS device communication, and so forth. In one embodiment, the contextual information relating to a conversation channel connection may include predefined identifiers which represent emotions, sounds (e.g., “ah,” “oops,” “wow,” etc.), and facial expressions in graphical symbols. In one embodiment, a call basics class 802 may be defined as a subtree structure of a VoIP namespace 800, which includes nodes such as call priority 803, namespace information 804, call type 805, destination numbers 806, service provider 807, predefined identifiers 808, and the like.

With reference to FIG. 8C, a block diagram of a call contexts class 810 is shown. In one embodiment, a subset of VoIP contextual information relating to conversation context may correspond to the call contexts class 810. The contextual information relating to conversation context may include information such as keywords supplied from a client, a service provider, network, etc., identified keywords from document file data, identified keywords from a conversation data packet (e.g., conversation keywords), file names for documents and/or multimedia files exchanged as part of the conversation, game related information (such as a game type, virtual proximity in a certain game), frequency of use (including frequency and duration of calls relating to a certain file, a certain subject, and a certain client), and file identification (such as a case number, a matter number, and the like relating to a conversation). The contextual information relating to conversation context may further include information relating to encryption (whether and/or how to encrypt contextual information) and subject of service (a type or nature of the service when a client requests such service from a service provider), among many others. In accordance with an illustrative embodiment, a call contexts class 810 may be defined as a subtree structure of a VoIP namespace 800 that includes nodes corresponding to file identification 812, supplied keyword 813, conversation keyword 814, frequency of use 815, encryption 816, service 820, and the like.

With reference to FIG. 8D, a block diagram of a device type class 830 is depicted. In one embodiment, a device type class 830 may correspond to a subset of VoIP contextual information relating to a VoIP client device used for the conversation channel connection. The subset of the VoIP contextual information relating to the VoIP client device may include audio related information that may be needed to process audio data generated by the VoIP client device. The audio related information may include information related to the device's audio functionality and capability, such as sampling rate, machine type, output/input type, microphone, digital signal processing (DSP) card information, and the like. The subset of the VoIP contextual information relating to the VoIP client device may include video related information that may be needed to process video data generated by the VoIP client device. The video related information may include resolution, refresh, type, and size of the video data, graphic card information, and the like. The contextual information relating to VoIP client devices may further include other device specific information such as type of the computer system, processor information, network bandwidth, wireless/wired connection, portability of the computer system, processing settings of the computer system, and the like. In an illustrative embodiment, a device type class 830 may be defined as a subtree structure of a VoIP namespace 800, which includes nodes corresponding to audio 832, video 834, device specific 836, and the like.

FIG. 8E depicts a block diagram of a VoIP client class 840. In accordance with an illustrative embodiment, a VoIP client class 840 may correspond to a subset of contextual information relating to VoIP clients. In one embodiment, the subset of the VoIP contextual information relating to the VoIP client may include voice profile information (e.g., a collection of information specifying the tonal and phonetic characteristics of an individual user), digital signature information, and biometric information. The biometric information can include user identification information (e.g., a fingerprint) related to biometric authentication, user stress level, user mood, etc. The subset of the VoIP contextual information relating to the VoIP client may include assigned phone number, user contact information (such as name, address, company, and the like), rules defined by the client, user preferences, digital rights management (DRM), a member rank of an individual user in an organization, priority associated with the member rank, and the like. The priority associated with the member rank may be used to assign priority to the client for a conference call. As will be described in greater detail below, the subset of the VoIP contextual information relating to the VoIP client may include inter-network information. In one embodiment, a VoIP client class 840 may be defined as a subtree structure of a VoIP namespace 800, which includes nodes corresponding to user biometrics 841, user preference 842, rules 843, user identification 844, member priority 845, location 846, network 850, and the like.

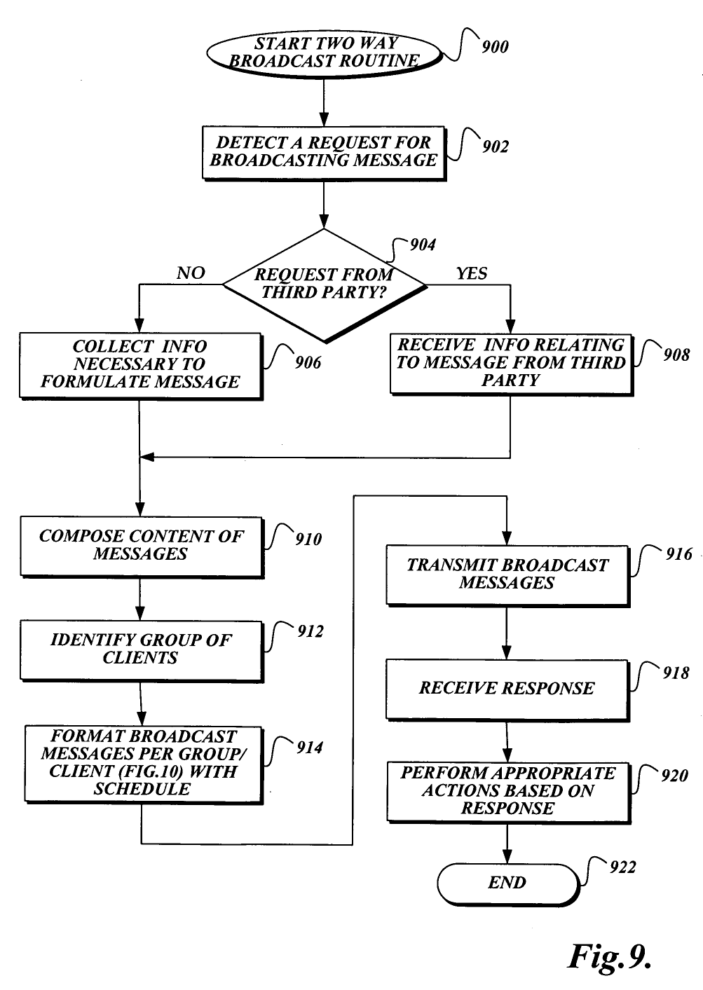

FIG. 9 is a flowchart illustrating a routine 900 for two-way broadcasting of messages in accordance with an embodiment of the present invention. For the purpose of discussion, assume that the service provider (e.g., a call center) may have several Emergency Broadcast (EB) third parties such as a national security related emergency broadcaster, a fire department related emergency broadcaster, a Federal Emergency Management Agency (FEMA) related emergency broadcaster, a service related emergency broadcaster, and the like. Each EB third party can request the service provider to broadcast a message to all or a certain group of clients.

Beginning at block 902, the service provider may detect a request for broadcasting messages. The request for broadcasting messages may be received from an authorized third party such as an EB third party, another service provider, a client, etc. Further, the request for broadcasting messages can be triggered upon detection of certain events in the service provider. At decision block 904, it is determined as to whether the request is from a third party. If it is determined at decision block 904 that the request is triggered by some events in the service provider, at block 906, the service provider collects information necessary to formulate messages. In one embodiment, the service provider may have a predefined set of events which will trigger a broadcast message to its clients. For example, the service provider may have predefined a set of rules specifying that if a possible cable failure event is detected, it will trigger a broadcast message to a group of clients who can be affected by the cable failure.

If it is determined that the request is from the third party, at block 908, the service provider receives information relating to a message from the third party. As mentioned above, the third party may include an EB third party, another service provider, a client, etc. In one embodiment, the information relating to a message may include the content of the message, priority information, scheduling information, duration of the broadcast, escalating message information, etc. In an illustrative embodiment, each EB third party may have different levels or sub-levels of priority based on a current emergency situation, an individual user's member ranking, or the like. Further, the service provider can obtain priority information from various sources. For example, the service provider may obtain its corresponding priority information from a centralized repository such as a centralized database server which may be centrally managed by either public or private entities. Alternatively, the service provider may obtain priority information from another service provider. It is contemplated that the service provider may have some logic to resolve any conflict among the information received from various sources.

At block 910, the content of the message may be composed based on collected or received information. At block 912, at least one group of clients (recipient clients) may be identified to receive several messages relating to the request of broadcasting messages. For example, a service provider decides to inform every client about a temporary bandwidth problem, but decides to broadcast a different message to its employees which instruct the employees not to burden the system's bandwidth. In this case, the content of a first message may be related to a temporary bandwidth problem; the content of a second message may be related to an instruction not to burden the system's bandwidth. Based on the content of the messages, two groups (a general client group and an employee group) may be identified.

At block 914, a broadcast message may be formulated for each identified group via formatting message subroutine 1000. As will be discussed in greater detail below, in some cases, a broadcast message may be formulated for each client based on client profile information such as capability and functionality of each client's devices, priority, etc. At block 916, the formulated broadcast messages may be transmitted to their destinations. Based on the priority information, the formulated broadcast messages may be scheduled for an orderly transmission of messages to clients. For example, the service provider has composed content of messages for three different groups having different priority levels. The service provider determines a priority level of each group and, based on the priority level of each group, determine a schedule to transmit a message. As such, the service provider may ensure that clients with a higher priority may be able to receive the broadcast messages before clients with a lower priority may. Upon receipt of the broadcast message, any recipient client may send a proper response to the service provider. For example, a proper response can be a simple confirmation of receipt of the broadcast message, a request for a service, a request for a conversation, etc. At block 920, the service provider may perform appropriate actions based on the received response. For example, if the response is a request to communicate with a third party, a digital voice channel connection will be routed to the third party and the digital voice channel connection is established between the third party and the corresponding recipient client. If the response indicates that the broadcast message failed to reach the corresponding recipient client, the broadcast message is transmitted via an alternative path. The routine 900 terminates at block 922.

It is to be understood that the embodiments explained in conjunction with the routine 900 are provided merely for example purposes. In one embodiment, a VoIP device may send a request to broadcast a message upon detection of problems without any human interaction. It is contemplated that the routine 900 can also be performed by a VoIP device acting as a hub for broadcasting. For example, a service provider can designate a VoIP device to propagate a message to other VoIP devices, to collect responses from other VoIP devices, and to provide the collected responses to the service provider. In this example, the service provider may act like a third party within routine 900. The designated VoIP device may receive a two-way broadcast message with a request to propagate (relay) the message from an originator which includes, but is not limited to, a service provider (e.g., an authorized call center) or other VoIP devices. The VoIP device may process the received broadcast message and determines an appropriate action. A user of the VoIP device may provide a proper input for propagating the messages. In some instances, a user of the VoIP device may reject the request to propagate. The VoIP device may compose content of a device broadcast message which is suitable for a transmission among devices. Subsequently, the VoIP device may determine a group of VoIP devices where the device broadcast message is transmitted based on a set of rules or instructions embedded in the messages. For example, the designated VoIP device may be requested to propagate the message to any VoIP devices located within 4 miles from the designate VoIP device. Additionally, the designated VoIP device may be requested to propagate the message to VoIP devices which are specified by the instructions. In one embodiment, the VoIP device may format a device broadcast message suitable for being received by each device from the group of VoIP devices. The VoIP device transmits the device broadcast message to its corresponding device. Alternatively, the VoIP device may simply forward the received messages to the group of VoIP devices. Subsequently, the VoIP device may receive responses from the group of VoIP devices and forward the responses to the originator. For example, when the VoIP device receives a confirmation of receipt about the device broadcast message, the VoIP device forwards the received confirmation to the originator.

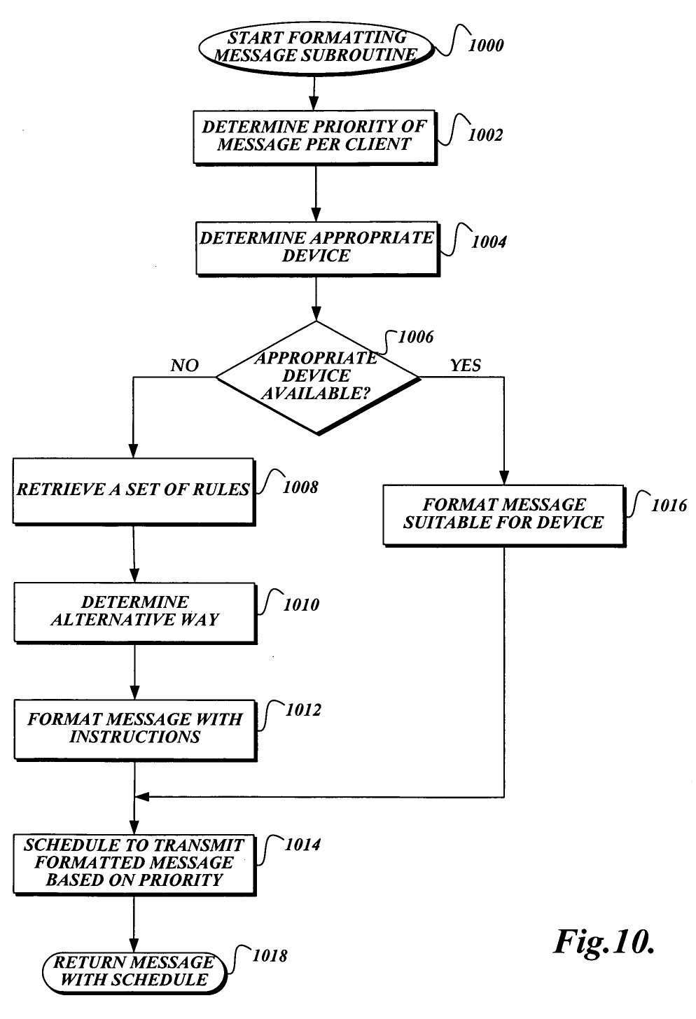

FIG. 10 illustrates a block diagram of a subroutine 1000 for formatting and scheduling messages in accordance with an embodiment of the present invention. As described in FIG. 9, the service provider may have detected a request to broadcast a message and the necessary information to formulate the message may have been collected and/or obtained from a proper source.

Beginning at block 1002, after at least one group of clients has been identified, a priority level of a client from the identified group may be determined. In one embodiment, several messages may be composed for the same group of clients. For example, in order to ensure that a client receives at least one message, a second message may be sent to the client within a predetermined period after a first message has been sent. For another example, several messages have been composed for subsets of a group of clients with a specified escalation level. Each message may be escalated differently for each subset of the group. Considering the example discussed in FIG. 9, the employee group may have three subsets: operators, field engineers, and managers. Operators may have level-1 escalation, field engineers may have level-2 escalation, and managers may have level-3 escalation. Messages for operators may not be escalated as fast as the message for managers may. As such, several messages can be formulated for a single client.

It is determined, at block 1004, which device of the client is appropriate to receive a message. At decision block 1006, a determination is made as to whether the appropriate device is available to receive a message. If it is determined at decision block 1006 that the appropriate device is available to receive a message, at block 1016, a message may be formatted suitable for the appropriate device receiving it. For example, in the client profile a certain device has been designated for receiving an emergency message. That device may be an appropriate device for the client. In case, the appropriate device has limited functionality (e.g., only able to communicate simple text information), the message will be formulated accordingly. In some cases, the simple text information may not be enough to notify a client of a certain event. In such a case, the simple text information may be sent to the appropriate device and a more detail message may be sent to another device of the client which has proper applications or functionality to process and/or display the detailed message. The simple text message may be used to notify the client to access another device which has received the detailed messages.

If it is determined at decision block 1006 that the appropriate device is not available, at block 1008, a set of rules specifying alternative paths for the client may be retrieved, or obtained. At block 1010, an alternative path to deliver the message to the client may be determined based on the set of rules. For example, the service provider may identify another client which can repeatedly forward the message to the client. Alternatively, the service provider may identify another client which can walk to inform the client due to proximity in geographic location. For example, Bob can walk over to Sara's office and tell her about the message. In some cases, the client may have designated a secondary contact for an emergency situation. In that case, the service provider may identify the secondary contact for the client. At block 1012, a message is formatted based on the determined alternative path.

After a message(s) is formatted for the client, at block 1014, a schedule for the message(s) will be determined. In one embodiment, when the messages are formatted, the messages are scheduled such that each recipient client is ensured to receive at least one message via its devices. In addition, broadcast messages can be scheduled based on priority information of the recipient clients. As such, the schedule can be determined based on a priority of the client among its associated group, a priority of the message(s) for a client, etc. In one embodiment, formatted messages may be queued in accordance with the schedule and be transmitted in order within the queue. The formatting message subroutine 1000 returns formatted messages and then terminates at block 1016.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for two-way message broadcasting over a digital voice communication channel, comprising:
composing content of a broadcast message;
identifying a first group of recipient clients based on the content;
formatting at least one broadcast message in accordance with profile information of a recipient client from the first group;
transmitting the formatted broadcast message to at least one corresponding recipient client; and
receiving a response to the transmitted broadcast message.

2. The method of claim 1 wherein formatting at least one broadcast message includes scheduling several broadcast messages with different formats, such that each recipient client is ensured to receive at least one of the several broadcast messages via a device of the recipient client.

3. The method of claim 2, wherein several broadcast messages are scheduled based on priority information of the recipient clients.

4. The method of claim 3 further comprising:
identifying a next group of recipient clients based on the response;
formatting at least one broadcast message in accordance with profile information of a recipient client from the identified next group;
transmitting the formatted broadcast message to at least one corresponding recipient client; and
receiving a response to the transmitted broadcast message from each recipient client.

5. The method of claim 5 further comprising:
upon receipt of the response, determining an appropriate action and performing the appropriate action.

6. The method of claim 1, further comprising:
if the response from the recipient client is a request to communicate with a third party, routing a digital voice channel connection to the third party with contextual information relating to the recipient client and the broadcast message; and
wherein the digital voice channel connection is established between the third party and the recipient client.

7. The method of claim 1, further comprising:
if the response from the recipient client requires further exchanging of a conversation, routing a digital voice channel to an appropriate contact with contextual information relating to the recipient client.

8. The method of claim 1, further comprising:
if the response from the recipient client indicates that the broadcast message failed to reach the recipient client, determining an alternative path to transmit the broadcast message to the recipient client and transmitting the broadcast message via the alternative path.

9. The method of claim 1, wherein composing content of a broadcast message includes receiving a request from an authorized party to broadcast a message and broadcast information relating to the message.

10. The method of claim 1, wherein the broadcast information includes information necessary to identify a group of recipient clients.

11. The method of claim 1, wherein the broadcast information includes information necessary to format, schedule, and/or transmit the message.

12. A method for communicating a two-way broadcast message via at least one VoIP device over a communication channel connection, comprising:
receiving a broadcast message from an authorized party;
upon receipt of the broadcast message, transmitting a response indicating a successful receipt of the broadcast message;
processing the received broadcast message;
determining an appropriate action based on the processed broadcast message and user inputs which are received as a digital voice conversation and contextual information; and
performing the determined appropriate action.

13. The method of claim 12, wherein performing the determined appropriate action includes:
composing content of a device broadcast message based on the processed broadcast message;
determining a group of VoIP devices to transmit the device broadcast message to;
formatting a device broadcast message based on receiving and processing capabilities of a device from the group of VoIP devices;
transmitting the device broadcast message to its corresponding device; and
receiving a confirmation of receipt about the transmitted device broadcast message.

14. The method of claim 13, further comprising:
forwarding the received confirmation to the authorized party.

15. The method of claim 12, wherein performing an appropriate action including transmitting a request to establish a channel connection with a third party.

16. The method of claim 12, wherein performing an appropriate action including transmitting the user input to at least one of the authorized party or a destination specified by the authorized party and receiving a response to the transmitted user input.

17. A computer-readable medium having computer-executable components for broadcasting a message, and subsequently allowing a two-way communication relating to the message, comprising:
a message component for receiving a request to broadcast a message and for generating content of the message;
a recipient device component for determining available devices of a recipient client based on the request;
a broadcasting component for formatting and transmitting a first broadcast message to the available device, the first broadcast message being tailored for an available device of the recipient client and including part of the content of the message; and
a communicating component for receiving a response to the first broadcast message and for communicating with the available device.

18. The computer-readable medium of claim 17, wherein if the recipient device component has not received a response from the available device of the recipient client for a predetermined time, the recipient device component retransmits the first broadcast message to another available device of the recipient client.

19. The computer-readable medium of claim 17, wherein if the recipient device component has received a response from the available device about the first broadcast message, the broadcast component formats a second message suitable for at least one available device of the recipient client based on the response and transmits the second message to the at least one available device.

20. The computer-readable medium of claim 17, wherein the request to broadcast is triggered by an authorized party.
